(19) United States
(12) Patent Application Publication
(10) Pub. No.: US 2026/0291125 A1
(43) Pub. Date: Sep. 24, 2026

(54) CONNECTOR ASSEMBLY

(71) Applicant: INFICON, INC., East Syracuse, NY (US)

(72) Inventors: Brian David DeLorenzo, Fayetteville, NY (US); Broderick Mark Keith, Pennellville, NY (US); Brianna Szczech, Syracuse, NY (US)

(73) Assignee: INFICON, INC., East Syracuse, NY (US)

(21) Appl. No.: 19/473,561

(22) PCT Filed: Apr. 26, 2024
(86) PCT No.: PCT/US2024/026446

§ 371 Date: Oct. 8, 2025

Related U.S. Application Data
(60) Provisional application No. 63/462,272, filed on Apr. 27, 2023.

(51) Int. Cl. H01R 13/627; H01R 12/71; H01R 12/75; H01R 13/11; H01R 13/193; H01R 24/28; H01R 43/26; H01R 105/00

(52) U.S. Cl. CPC H01R 13/6273; H01R 12/716; H01R 12/75; H01R 13/111; H01R 13/193; H01R 24/28; H01R 43/26; H01R 2105/00; H01R 2201/20

(57) ABSTRACT

A connector assembly includes a housing including a terminal interface at the first end defining a plurality of interface openings. A securing portion is structured to pivot relative to the housing and a plurality of connector contacts are structured to at least be partially positioned in the plurality of interface openings. A plurality of biasing members are each operatively coupled to one of the plurality of connector contacts and structured to bias each of the plurality of connector contacts to maintain contact with a terminal of the first device. The securing portion is structured to pivot inward to release the housing from the first device and pivot outward to secure the housing to the first device and inhibit the housing from being pulled away from the first device. Each of the plurality of connector contacts is further in electrical contact with at least one input from the second device.

### CROSS-REFERENCE TO RELATED APPLICATION

This application claims the benefit and priority of U.S. Provisional Patent Application No. 63/462,272, filed on Apr. 27, 2023. The entire contents of said application are incorporated herein by reference.

### TECHNOLOGICAL FIELD

This following disclosure relates generally to the field of data transfer and more specifically a multi-port connector assembly that enables proper alignment and a consistent connection to a controller.

### BACKGROUND

Fabrication assemblies/systems for semiconductor, display and solar manufacturers require precise control in order to maximize profitability and minimize the number of scrapped wafers. In many instances sophisticated software applications are used to monitor various processes of these fabrication assemblies in order to increase productivity and identify problems in order to minimize downtime. In order to provide system data to the software application for analysis, it is necessary to transfer the data from a controller. Currently, this requires multiple cables to be clipped directly onto corresponding connections or pins on the controller. This is not only a tedious process and the use of multiple wires aesthetically unpleasing, but it is also fraught with error since the clips must be connected in a specific configuration in order to enable proper transmission. Moreover, the clips can cause damage to the connections during removal or even breakage if the clips are attempted to be pulled from the connections.

These are just some of the problems associated with the current transfer of data from a controller.

### BRIEF SUMMARY

This disclosure is directed to a connector or connector assembly that allows data to be collected off of a controller and transferred to be analyzed in a monitoring and analyzation device. Data can be collected from the controller in the short and long term. The disclosed connector is much easier to install and is much more aesthetically pleasing that the currently used clips or clamps, such as alligator clamps. Instead of requiring multiple (3) individual clips connected directly to the pins of the controller, the disclosed connector uses a singular cable with a friction connection to the controller without directly coupling to the controller pins. Not only is this connection more secure than the clips being currently used, but it also greatly reduces the risk of damage to the pins.

An embodiment of a connector assembly is configured to enable transfer of information between a first device and a second device. The connector assembly includes a housing extending from a first end to a second end and further including a positioner configured to properly orient the housing relative to a terminal of the first device, and a terminal interface at the first end defining a plurality of interface openings. A securing portion is structured to pivot relative to the housing and a plurality of connector pins are each structured to at least be partially positioned in a corresponding interface opening and connected to at least one input from the second device. A plurality of biasing members are each operatively coupled to one of the plurality of connector pins and configured to bias each of the plurality of connector pins to maintain contact with the terminal of the first device. The securing portion is structured to pivot inward to release the housing from the terminal and pivot outward to secure the housing to the terminal and inhibit the housing from being pulled away from the first device.

In an embodiment, the data transfer connector assembly further includes one or more securing members positioned towards the first end and coupled to the securing portion. In an embodiment, the one or more securing members are structured to engage a surface of the terminal to inhibit removal of the housing from the terminal. In an embodiment, the securing portion is structured to pivot inward to release the one or more securing members from the terminal and to pivot outward to engage the one or more securing members to the terminal and inhibit the housing from being pulled away from the terminal. In an embodiment of the connector assembly, each of the plurality of connector pins includes a first pin portion configured to engage the terminal and a second pin portion configured to couple to one of the plurality of biasing members. The one of the plurality of biasing members is configured to exert a biasing force on the first pin portion to maintain contact between the first pin portion and the terminal. In another embodiment of the data transfer connector, the housing further includes a stop member structured to inhibit an over insertion of the housing onto the terminal. In a further embodiment, the connector assembly includes a rim structured to at least partially surround the terminal interface and form a friction fit with a portion of the first device.

An embodiment of a connector assembly structured to facilitate a transfer of information between a first device and a second device includes a housing that extends from a first end to a second end. The first end include a terminal interface defining a plurality of interface openings. A securing portion is structured to pivot relative to the housing and a plurality of connector contacts are structured to at least be partially positioned in each of the plurality of interface openings. A plurality of biasing members are each operatively coupled to one of the plurality of connector contacts and structured to bias each of the plurality of connector contacts to maintain contact with a terminal of the first device. The securing portion is structured to pivot inward to release the housing from the terminal of the first device and to pivot outward to secure the housing to the first device and inhibit the housing from being pulled away from the terminal of the first device. Each of the plurality of connector contacts is in electrical contact with at least one input from the second device. In an embodiment, the connector assembly further includes a rim configured to at least partially surround the first end and create a friction fit with a portion of the first device. In a further embodiment, the rim extends from the terminal interface.

An embodiment of a method of transferring information between a first device and a second device includes structuring a data connector assembly to comprise a housing extending between a first end and a second end and comprising a terminal interface at the first end defining a plurality of interface openings. A securing portion is structured to pivot relative to the housing and a plurality of connector contacts each structured to at least be partially positioned in each of the plurality of interface openings in order to contact a terminal of the first device. The plurality of connector contacts are further configured to electrically connect to at least one input from the second device. The securing portion is pivoted inwards relative to the housing and the terminal interface of the housing is inserted into a terminal of the first device. The plurality of connector contacts is biased into contact with the terminal of the first device to maintain an electrical communication between the first device and the second device to enable a transfer of information between the first device and the second device. The securing portion is pivoted outwards relative to the housing to secure the housing to a surface of the first device and inhibit the housing from being pulled away from the terminal of the first device. The information is then transferred between the first device and the second device via the plurality of contacts.

In an embodiment, the securing portion is structured to include one or more securing members positioned towards the first end and structured to engage a surface of the first device to inhibit removal of the housing from the terminal of the first device. Another embodiment includes structuring the housing to include a positioner structured to facilitate a specific orientation of the housing relative to the terminal of the first device. The transfer of information between the first device and the second device only occurs when the housing is positioned at the specific orientation. A further embodiment includes structuring each of the plurality of connector contacts to include a first contact portion configured to engage the terminal of the first device and a second contact portion coupled to one of the plurality of biasing members. The one of the plurality of biasing members is structured to exert a biasing force on the first contact portion to maintain contact between the first contact portion and the terminal.

### BRIEF DESCRIPTION OF DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings in which:

FIG. 1 schematically illustrates a prior art example of transferring data from a first device to a second device using a plurality of clips.

FIG. 2 schematically illustrates an enlarged portion of the first device from FIG. 1 with a plurality of terminal pins and corresponding clamps for clamping onto each terminal pin.

FIG. 3 illustrates a perspective front view of an embodiment of a connector assembly according to the disclosed invention.

FIG. 4 illustrates another perspective front view of the embodiment of the connector assembly of FIG. 3.

FIG. 5 illustrates a front view of the embodiment of the connector assembly of FIG. 3 showing the terminal interface.

FIG. 6 illustrates another front view of the connector assembly according to the disclosed invention.

FIG. 7 illustrates a sectional view of the embodiment of FIG. 6 along A-A.

FIG. 8 illustrates a longitudinal sectional view of the embodiment of FIG. 6.

FIG. 9A illustrates a perspective view of the embodiment of the connector assembly of FIG. 3 coupled to a plurality of outputs from a analyzer/monitoring device.

FIG. 9B illustrates another perspective view of the embodiment of the connector assembly of FIG. 3 coupled to a plurality of outputs from a analyzer/monitoring device through an output interface.

FIG. 10 illustrates an exploded view of an embodiment of the connector body and plurality of connector pins showing first and second pin portions.

FIG. 11 illustrates a cross-sectional view of an embodiment of the connector assembly.

FIG. 12 illustrates a close up, enlarged view of the terminal interface of FIG. 11.

FIG. 13 illustrates a plan view of an embodiment of a housing of the connector assembly.

FIG. 14 illustrates a front view of the embodiment of the housing of FIG. 13.

FIG. 15 illustrates a perspective view of the housing of FIG. 13 showing the positioner.

FIG. 16 illustrates another plan view of the opposing of the housing of FIG. 13.

FIG. 17 illustrates a sectional view of a controller terminal with an embodiment of the connector assembly being installed.

FIG. 18 illustrates another sectional view of a controller terminal with an embodiment of the connector assembly being installed.

### DETAILED DESCRIPTION

The following discussion relates to various embodiments of a data connector assembly. It will be understood that the herein described versions are examples that embody certain inventive concepts as detailed herein. To that end, other variations and modifications will be readily apparent to those of sufficient skill. In addition, certain terms are used throughout this discussion in order to provide a suitable frame of reference with regard to the accompanying drawings. These terms such as “upper”, “lower”, “forward”, “rearward”, “interior”, “exterior”, “front”, “back”, “top”, “bottom”, “inner”, “outer”, “first”, “second”, and the like are not intended to limit these concepts, except where so specifically indicated. The terms “about” or “approximately” as used herein may refer to a range of 80%-125% of the claimed or disclosed value. With regard to the drawings, their purpose is to depict salient features of the data connector assembly and are not specifically provided to scale.

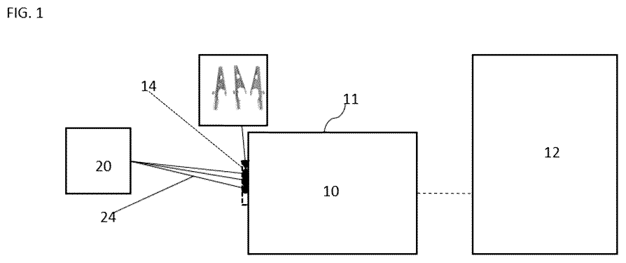

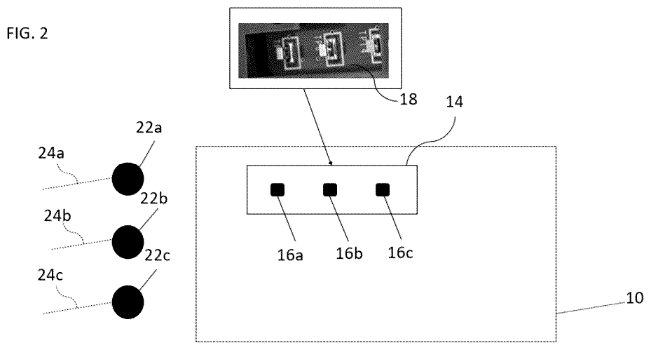

FIGS. 1 and 2 schematically illustrate a first device 10 being electrically coupled to a second device 20 such that information, which may comprise one or more signals, is transferred between the first device 10 and the second device 20. As shown, the first device 10 may be in electrical communication with one or more components of an assembly 12 such that information from the one or more components of the assembly 12 are may be transferred through the first device 10 and on to the second device 20. The information may include digital signals, analog signals, or any other type of information as may be transferred between the first and second devices 10, 20. The first device 10 may generally include a housing 11 surrounding some or all of the components of the first device 10 including a terminal 14 with a terminal board 18. The terminal board 18 of the first device 10 may include a plurality of terminal pins or terminal contacts. As shown, the terminal 14 of the first device 10 includes three (3) terminal pins 16a, 16b, 16c.

The second device 20 may be, as shown, an analyzer/monitoring device that includes a plurality of outputs 24 that connect to the terminal pins 16a, 16b, 16c in order to facilitate a transfer of information, such as data information or other signals gathered by the first and/or second devices 10, 20. As shown, the second device 20 has three (3) individual inputs 24a, 24b, 24c that each include a clamp 22a, 22b, 22c, such as an alligator clamp, that clamps onto or at least partially around a corresponding terminal pin 16a, 16b, 16c. The clamps 22a, 22b, 22c must be attached to or secure onto each of the terminal pins 16a, 16b, 16c in a specific order for proper operation and transfer of information between the first and second devices 10, 20. As is readily apparent from FIGS. 1 and 2, it is easy to confuse the order of the individual inputs 24a, 24b, 24c and connect them in the wrong order to the first device 10. Moreover, the mechanical clamping onto the terminal pins 16a, 16b, 16c may cause undue wear or deformation of the terminal pins 16a, 16b, 16c overt time, which may interfere with the information transfer between the first and second devices 10, 20. In addition, the mechanical clamping may lead to breakage or removal of the terminal pins 16a, 16b, 16c if one or more of the clamps 22a, 22b, 22c is attempted to be pulled from its corresponding terminal pin. In addition, the plurality of inputs 24a, 24b, 24c increases the chances of entanglement, which can also lead to terminal pin damage/breakage.

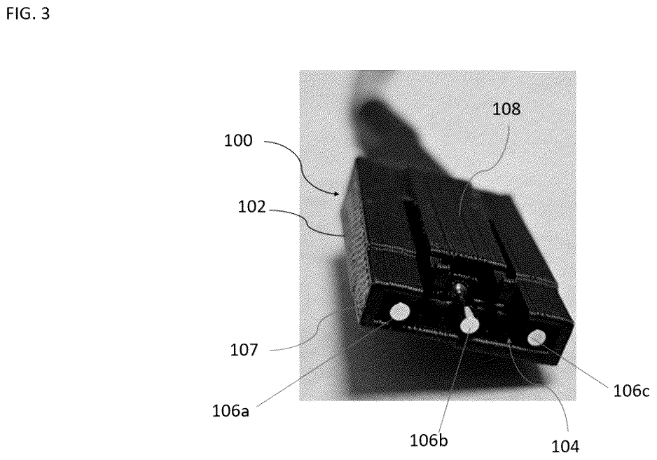

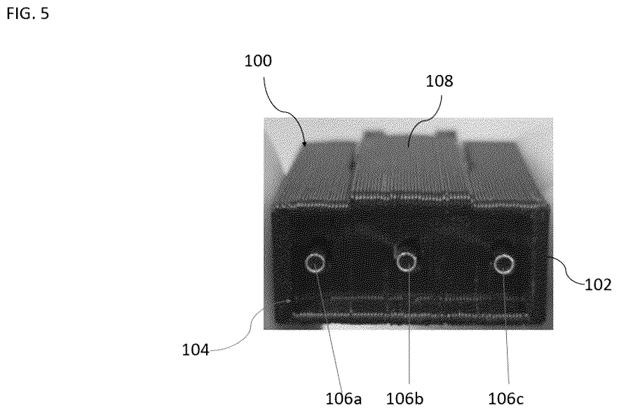

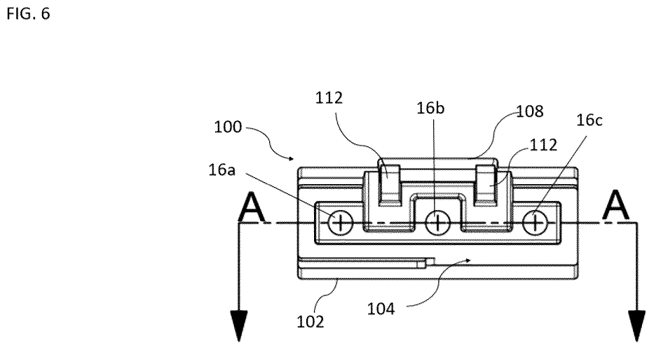

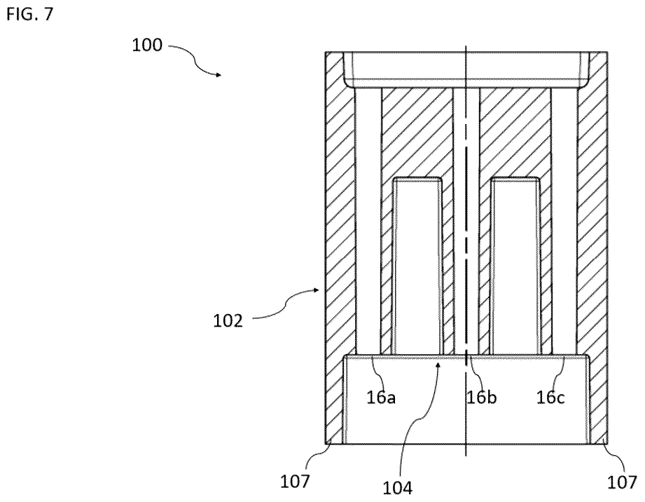

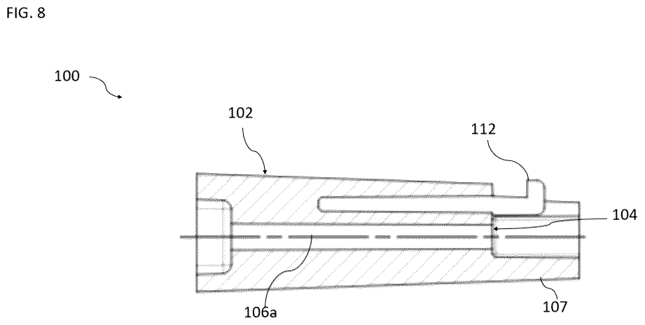

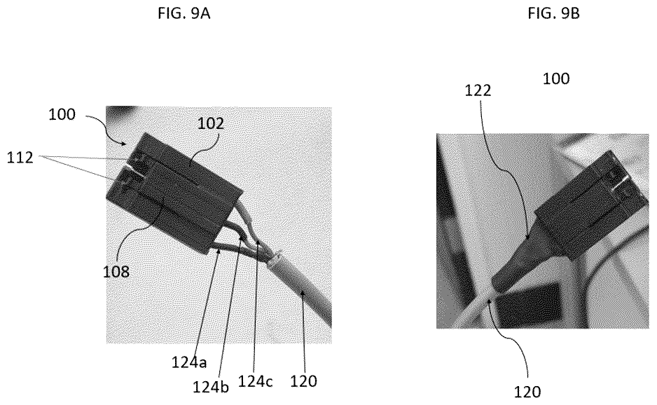

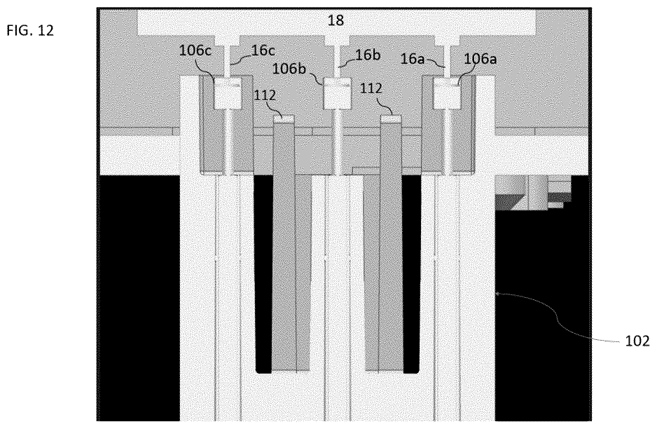

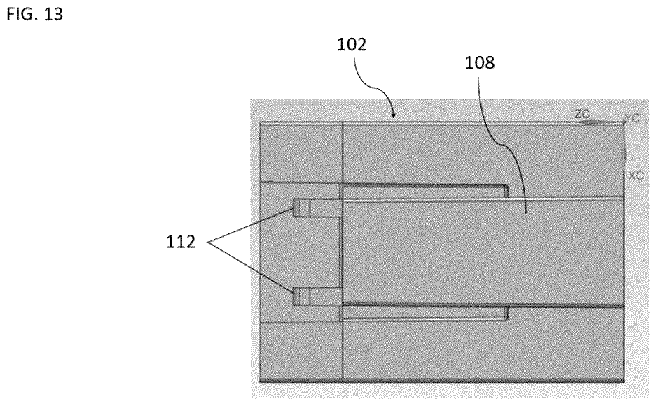

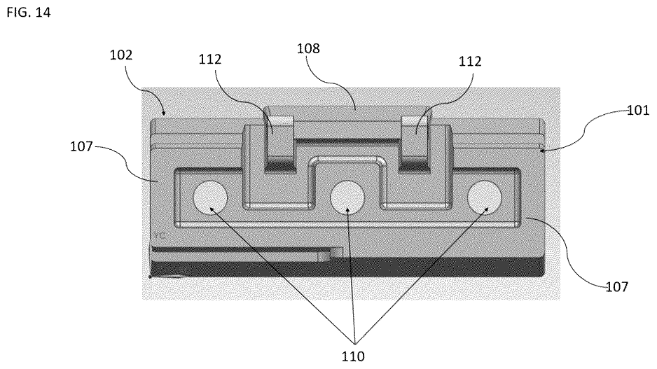

The inventive multi-port connector assembly or connector 100 will now be described with general reference to FIGS. 3-16. As shown, the connector 100 includes a housing 102 with a first end 101 and a second end 103. The first end includes a terminal interface 104 that is at least partially surrounded by a lip or rim 107 that extends from the terminal interface 104. The terminal interface 104 defines a plurality of interface openings 110 (FIG. 14) that are each dimensioned to at least partially accept a connector contact or connector pin 106a, 106b, 106c. The second end 103 of the housing 102 is structured to accept a plurality of inputs 124a, 124b, 124c (FIG. 9A) from the second device 20 as shown schematically in FIG. 1. FIGS. 9A and 9B show that the plurality of inputs 124a, 124b, 124c may be housed in a single output cable 120 and may be connected to the connector 100 through an output interface 122.

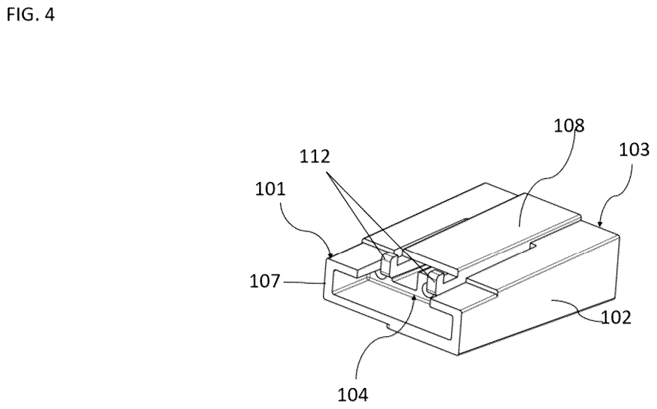

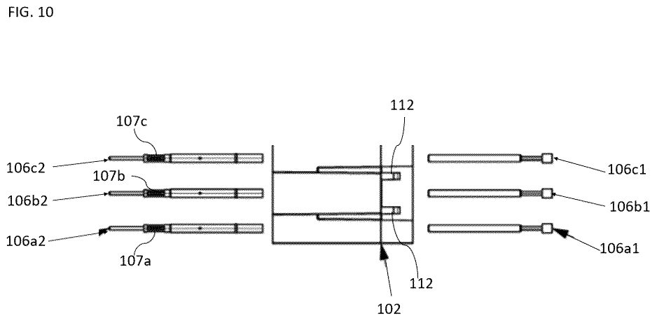

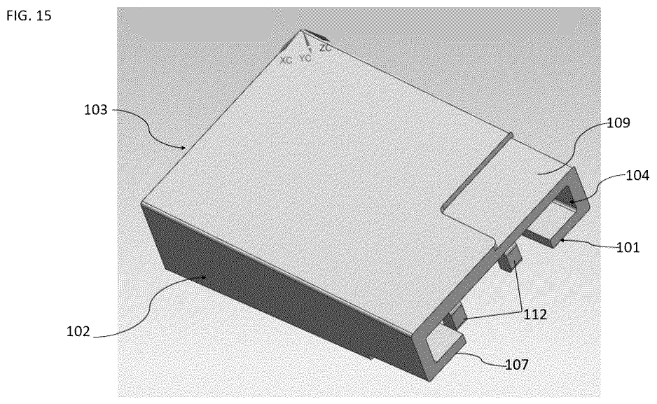

The housing 102 further includes a locking portion or a securing portion 108 that is structured to be pivoted or otherwise displaced relative to the rest of the housing 102. The securing portion 108 includes one or more securing members 112 that extend from the securing portion 108. As shown particularly in FIGS. 4, 8, 16, the one or more securing members 112 are “L-shaped” extensions. The housing 102 further includes a positioner 109 (FIG. 15) that is structured to properly orient the housing 102 when the connector 100 is installed into the terminal 14 so as to ensure proper orientation of the connector pins 106a, 106b, 106c relative to the terminal pins 16a, 16b, 16c. As shown, the positioner 109 comprises a recessed or depressed portion of the housing 102, however in other embodiments the positioner 109 may comprise one or more alternative surface features that aid in the proper alignment of the connector 100 relative to the terminal 14. As previously discussed, information transfer can only occur through the connector 100 when the each of the connector pins 106a, 106b, 106c interacts with the proper corresponding terminal pin 16a, 16b, 16c. Accordingly, the positioner 109 inhibits installation of the connector 100 onto the terminal 14 of the first device 10 in more than one orientation. As shown in the embodiment of FIG. 10, each of the connector pins 106a, 106b, 106c may comprise a first contact portion or a first pin portion 106a1, 106b1, 106cl and a corresponding second contact portion or second pin portion 106a2, 106b2, 106c2. A biasing member 107a, 107b, 107c is structured to exert a biasing force on the first pin portion 106a1, 106b1, 106cl of each connector pin 106a, 106b, 106c. In an embodiment, the biasing member is a resilient member. In an embodiment, the resilient member is a spring member capable of generating a force when compressed.

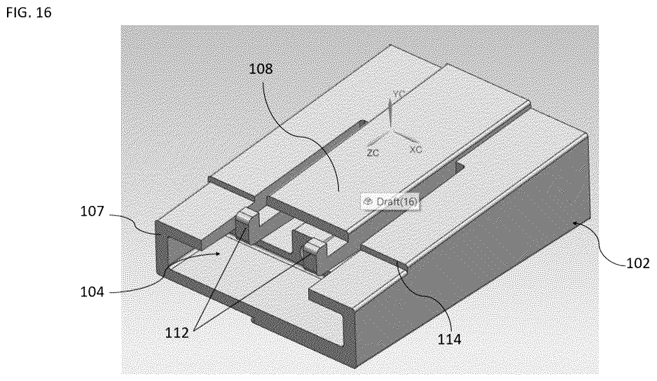

Installation of the connector 100 at the terminal 14 of the first device 10 will now be discussed with general reference to FIGS. 10, 12 and 15-18. As was previously mentioned, the positioner 109 of the housing 102 inhibits installation of the connector 100 onto the first device 10 in an incorrect orientation. When connecting the connector 100 to the terminal 14, the securing portion 108 is depressed so as to pivot the securing members 112 inward or otherwise towards the housing 102. The housing 102 is advanced onto the terminal 14 until the housing 102 cannot be advanced further. In an embodiment, the housing 102 includes a stop member 114 (FIG. 16) that inhibits over insertion of the connector 100 onto the terminal 14. In an embodiment, the rim 107 may further produce a friction fit with a portion of the terminal 14.

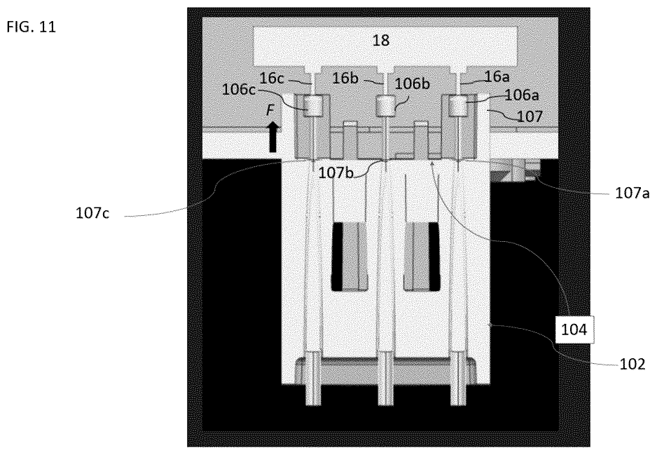

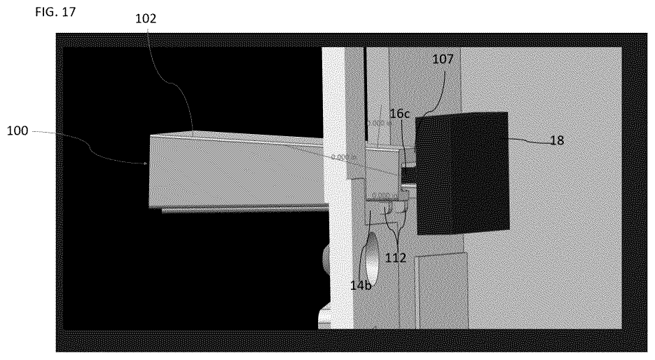

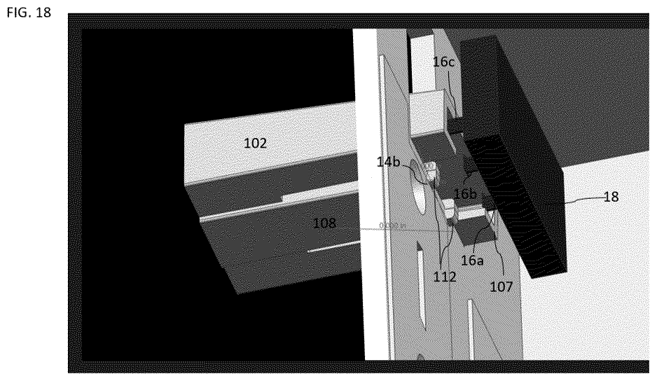

Once the housing 102 is positioned on the terminal 14, the securing portion 108 is released such that the securing members 112 pivot outward (i.e., away from the housing 102) and engage an inner surface 14b of the terminal 14 (FIGS. 17 and 18). The securing members 112 inhibit the connector 100 from being pulled away from the terminal 14. When the securing members 112 are engaged with the inner surface 14b of the terminal 14, the connector pins 106a, 106b, 106c contact the corresponding terminal pins 16a, 16b, 16c. The first pin portions 106a1, 106b1, 106cl contact the corresponding terminal pins 16a, 16b, 16c and compress the biasing members 107a, 107b, 107c. The biasing members 107a, 107b, 107c in turn exert a biasing force F (FIG. 11) which acts to bias the first pin portions 106a1, 106b1, 106cl to maintain contact with the corresponding terminal pin 16a, 16b, 16c. Accordingly, the connector pins 106a, 106b, 106c contact the terminal pins 16a, 16b, 16c but are not mechanically coupled to the terminal pins 16a, 16b, 16c, such as by using clamps. In this manner, a reliable connection between the connector 100 and the analyzer/monitoring device 20 is maintained and the terminal pins 16a, 16b, 16c are protected against deformation and breakage.

To remove or uninstall the connector 100 from the terminal 14 of the controller 10, the securing portion 108 is depressed to pivot the securing members 112 inward and out of engagement with the inner surface 14b of the terminal 14. The connector 100 may then be pulled away from the terminal 14. The biasing members 107a, 107b, 107c relax as the removal of the connector 100 causes the connector pins 106a, 106b, 106c to be moved out of contact with the terminal pins 16a, 16b, 16c.

When the connector 100 is installed onto the terminal 14 of the first device 10, information may be transmitted between the first device 10 and the second device 20. In an embodiment, the first device 10 may be a controller that is in electrical communication to one or more components of a semiconductor fabrication assembly. In an embodiment, the one or more components may include robots or robotic assemblies, one or more sensors, reagent dispensers, and/or other suitable components that may require monitoring/regulation. In an embodiment, the second device 20 is structured to record and analyze the information received through the connector 100 and issue a warning signal when an information parameter is outside a predetermined parameter range. In other embodiments, the first device 10 may not be part of the semiconductor assembly and may be any other device in which information is generated and/or stored.

The housing 102 of the connector 100 may be comprised of a rigid, non-conductive material. In an embodiment, the housing 102 includes a material comprised of one or more polymers, such as a plastic. The connector pins 106a, 106b, 106c may be comprised of a conductive material or a material that otherwise conducts a flow of electrical current. In an embodiment, the conductive material may be a pure metal or an alloy. The disclosed connector 100 enables a quick, easy, and a reliable terminal connection every time without having to detangle connector leads. Moreover the biasing capabilities of the connector pins 106a, 106b, 106c maintains a consistent electrical connection with the terminal pins 16a, 16b, 16c of the terminal

While the present invention has been particularly shown and described with reference to certain exemplary embodiments, it will be understood by one skilled in the art that various changes in detail may be effected therein without departing from the spirit and scope of the invention that can be supported by the written description and drawings. Further, where exemplary embodiments are described with reference to a certain number of elements, it will be understood that the exemplary embodiments can be practiced utilizing either less than or more than the certain number of elements.

1. A connector assembly configured to enable transfer of data between a first device and a second device, comprising:
a housing extending from a first end to a second end and comprising,
a positioner configured to properly orient the housing relative to a terminal of the first device, and
a terminal interface at the first end defining a plurality of interface openings;
a securing portion configured to pivot relative to the housing,
a plurality of connector pins configured to at least be partially positioned in the plurality of interface openings and connected to at least one input from the second device; and
a plurality of biasing members, wherein each of the plurality of biasing members are operatively coupled to one of the plurality of connector pins and configured to bias each of the plurality of connector pins to maintain contact with corresponding terminal pins of the terminal of first device, wherein the terminal pins are coupled to a terminal PCB,
wherein the securing portion is configured to pivot inward to release the housing from the terminal of the first device and pivot outward to secure the housing to the first device and inhibit the housing from being pulled away from the first device, wherein the securing portion is configured to engage a terminal surface that is positioned away from the PCB.

2. The connector assembly of claim 1, further comprising one or more securing members positioned towards the first end and coupled to the securing portion.

3. The connector assembly of claim 2, wherein the one or more securing members are structured to engage a surface of the terminal to inhibit removal of the housing from the first device.

4. The connector assembly of claim 3, wherein the securing portion is configured to pivot inward to release the one or more securing members from the surface and pivot outward to engage the one or more securing members to the surface and inhibit the housing from being pulled away from the terminal of the first device.

5. The connector assembly of claim 1, wherein each of the plurality of connector pins comprises:
a first pin portion configured to contact the terminal; and
a second pin portion configured to couple to one of the plurality of biasing members,
wherein the one of the plurality of biasing members is configured to exert a biasing force on the first pin portion to maintain contact between the first pin portion and the terminal, wherein the surface of the terminal is located towards the first pin portion.

6. The connector assembly of claim 1, wherein the housing further includes a stop member configured to inhibit an over insertion of the housing onto the terminal.

7. The connector assembly of claim 1, further comprising a rim configured to at least partially surround the terminal interface and form a friction fit with a portion of the first device.

8. A connector assembly configured to facilitate a transfer of information between a first device and a second device, comprising:
a housing extending from a first end to a second end and comprising a terminal interface defining a plurality of interface openings;
a securing portion configured to pivot relative to the housing;
a plurality of connector contacts configured to at least be partially positioned in the plurality of interface openings; and
a plurality of biasing members, wherein each of the plurality of biasing members are operatively coupled to one of the plurality of connector contacts and configured to bias each of the plurality of connector contacts to maintain contact with a corresponding terminal pin extending from a PCB at a terminal of the first device,
wherein the securing portion is configured to pivot inward to release the housing from the terminal of the first device and pivot outward to secure the housing to the first device and inhibit the housing from being pulled away from the terminal of the first device,
wherein the securing portion is configured to engage a terminal surface that is positioned away from the PCB, and
wherein each of the plurality of connector contacts is in electrical contact with the second device.

9. The connector assembly of claim 8, further comprising one or more securing members positioned towards the first end and coupled to the securing portion, wherein the one or more securing members are structured to engage a surface of the terminal of the first device to inhibit removal of the housing from the first device.

10. The connector assembly of claim 9, wherein the securing portion is configured to:
pivot outward to engage the one or more securing members to the terminal of the first device and inhibit the housing from being pulled away from the terminal of the first device; and
pivot inward to release the one or more securing members from the terminal of the first device.

11. The connector assembly of claim 8, wherein each of the plurality of connector contacts comprises:
a first contact portion configured to contact the terminal of the first device; and
a second contact portion configured to couple to one of the plurality of biasing members,
wherein the one of the plurality of biasing members is configured to exert a biasing force on the first contact portion to maintain contact between the first contact portion and the terminal of the first device.

12. The connector assembly of claim 8, wherein the housing further includes a stop member configured to inhibit an over insertion of the housing onto the terminal of the first device.

13. The connector assembly of claim 8, further comprising a rim configured to at least partially surround the first end and create a friction fit with a portion of the first device.

14. The connector assembly of claim 13, wherein the rim extends from the terminal interface.

15. The connector assembly of claim 8, further comprising a positioner configured to cooperate with the terminal of the first device to facilitate a specific orientation of the housing relative to the terminal of the first device.

16. The connector assembly of claim 15, wherein:
the specific orientation ensures contact between each of the plurality of contacts with a specific corresponding terminal contact; and
the transfer of information between the first and second devices only occurs when the housing is at the specific orientation.

17. A method of transferring information between a first device and a second device, comprising:
structuring a data connector assembly to comprise,
a housing extending between a first end and a second end and comprising a terminal interface at the first end defining a plurality of interface openings,
a securing portion configured to pivot relative to the housing, and
a plurality of connector contacts configured to at least be partially positioned in the plurality of interface openings in order to contact a terminal of the first device, and further configured to electrically connect to at least one input from the second device;
pivoting the securing portion inwards relative to the housing;
inserting the terminal interface of the housing into a terminal of the first device;
biasing the plurality of connector contacts into contact with corresponding terminal contacts extending from a PCB at the terminal of the first device to maintain an electrical communication between the first device and the second device to enable a transfer of information between the first device and the second device;
pivoting the securing portion outwards relative to the housing to secure the housing to a surface of the first device away from the terminal PCB and inhibit the housing from being pulled away from the terminal of the first device; and
transferring information between the first device and the second device via the plurality of contacts.

18. The method of claim 17, further comprising:
structuring the securing portion to include one or more securing members positioned towards the first end and configured to engage a surface of the first device to inhibit removal of the housing from the terminal of the first device; and
structuring the housing to include a positioner configured to cooperate with the terminal of the first device to facilitate a specific rotational orientation of the housing relative to the terminal of the first device, wherein the transfer of information between the first device and the second device only occurs when the housing is positioned at the specific orientation.

19. The method of claim 17, further comprising structuring each of the plurality of connector contacts comprises:
a first contact portion configured to engage the terminal of the first device; and
a second contact portion configured to couple to one of the plurality of biasing members,
wherein the one of the plurality of biasing members is configured to exert a biasing force on the first contact portion to maintain contact between the first contact portion and the terminal.

20. The method of claim 17, further comprising:
analyzing the transferred information; and
generating a warning signal when a parameter of the transferred information is outside a predetermined parameter range.
